(19) United States
(12) Patent Application Publication
(10) Pub. No.: US 2011/0032568 A1
(43) Pub. Date: Feb. 10, 2011

(54) PRINTING APPARATUS AND PRINTING CONTROL METHOD

(75) Inventor: Takeshi Takahashi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/848,793

(22) Filed: Aug. 2, 2010

(30) Foreign Application Priority Data
Aug. 4, 2009 (JP) 2009-181874

(51) Int. Cl. G06F 15/00

(52) U.S. Cl. 358/1.15

(57) ABSTRACT

A printing apparatus includes a log information acquisition unit configured, if a print source is a print server, to acquire log information from the print server, or if the print source is a client apparatus, to acquire log information from a log management server in which the client apparatus writes the log information, and a control unit configured to execute printing related to a print job when the log information is acquired by the log information acquisition unit.

### BACKGROUND OF THE INVENTION

1. Field of the Invention

The present invention generally relates to printing and, more particularly, to a printing apparatus, a printing control method, and a program.

2. Description of the Related Art

Log information managed by a device has usually been limited. For example, login identification (ID) for a device is managed by the device (by using corporate section ID, in many cases), but it does not necessarily provide information enough to identify an individual user. Therefore, for purposes of audit, for example, it is desirable for a print source (a client personal computer (PC), for example) to store more pieces of information liked with a print log of the device to provide sufficient log information.

Japanese Patent Application Laid-Open No. 2004-171325 discusses a technique in which a printer determines whether or not to execute a print job based on printing conditions, such as a print sheet and resolution, collected in print job units in a print server, and, if printing cannot be performed, notifies the print server of a result of determination.

Under the present circumstances, however, there is a problem that the printing apparatus will print out a document even if the print source does not have log information.

### SUMMARY OF THE INVENTION

According to the present invention, when a print source does not output log information, a printing apparatus can perform control to prohibit printing not to output data on paper.

According to an aspect of the present invention, a printing apparatus includes a log information acquisition unit configured, if a print source is a print server, to acquire log information from the print server, or if the print source is a client apparatus, to acquire log information from a log management server in which the client apparatus writes the log information, and a control unit configured to execute printing related to a print job when the log information is acquired by the log information acquisition unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a printing system according to a first exemplary embodiment of the present invention.

FIG. 2 schematically illustrates a hardware configuration of a printing apparatus.

FIG. 3 illustrates an example of a detailed configuration of the printing apparatus.

FIG. 4 illustrates an example of a hardware configuration which is common to a client PC, a logging server, a policy management server, and a print server.

FIGS. 5A, 5B, 5C, and 5D illustrate examples of software configurations of the client PC, the logging server, the policy management server, and the print server.

FIG. 6 illustrates an example of log information.

FIG. 7 illustrates an example of policy information which is described in an extensible markup language (XML) format.

FIG. 8 is a flowchart illustrating an example of print control processing executed in the printing apparatus according to the first exemplary embodiment of the present invention.

FIG. 9 is a flowchart illustrating an example of acquisition processing of policy information.

FIG. 10 is a flowchart illustrating an example of acquisition processing of log information.

FIG. 11 is a flowchart illustrating an example of print control executed in a printing apparatus according to a second exemplary embodiment of the present invention.

FIG. 12 illustrates an example of a print system configuration according to the second exemplary embodiment of the present invention.

### DESCRIPTION OF THE EMBODIMENTS

Various exemplary embodiments, features, and aspects of the invention will be described in detail below with reference to the drawings.

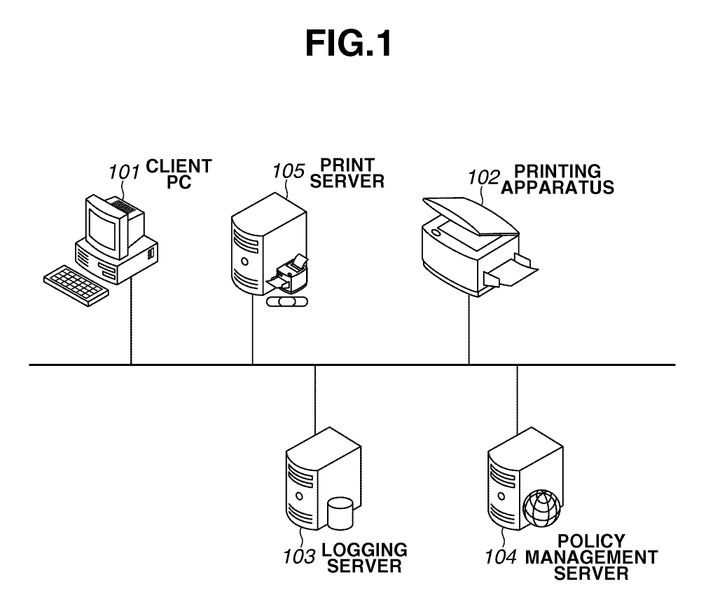

FIG. 1 illustrates an example of a system configuration of a printing system according to a first exemplary embodiment of the present invention. The printing system according to the present exemplary embodiment is formed by including a client PC 101, a printing apparatus 102, a logging server 103, a policy management server 104, and a print server 105. Each unit is connected to each other on a network. The logging server 103 is an example of a log management server. The printing apparatus may be in the form of a multi-function peripheral (MFP), or may be a printer, a copier, or a facsimile.

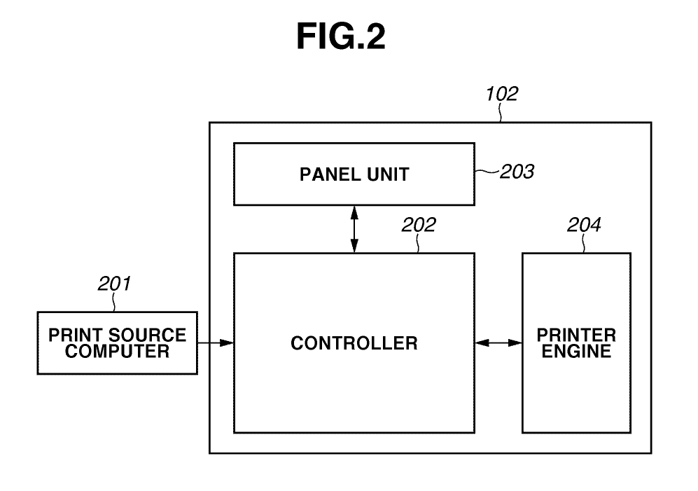

Referring to FIG. 2, an example of a configuration of the printing apparatus according to the present exemplary embodiment will be described below. FIG. 2 illustrates a general outline of a hardware configuration of the printing apparatus. A print source computer 201 is a client PC (client device) 101 or the print server in the present exemplary embodiment, and functions as a source to supply image information or a control device of a printer.

The printing apparatus 102 includes a controller 202, a panel unit 203, and a printer engine 204. The controller 202 generates raster data for each page based on image information (escape (ESC) code, page description language, or the like) supplied from the print source computer 201, and transmits the raster data to the printer engine 204.

Based on the raster data supplied from the controller 202, the printer engine 204 records an image by forming a latent image on a photosensitive drum, and transferring and fixing the latent image on paper (electrophotographic method). The printer engine 204 may operate using an inkjet printing method or any other printing method.

The panel unit 203 is used as a user interface. A user can instruct the printing apparatus 102 to perform a desired operation by using the panel unit 203. The panel unit 203 displays processing contents of the printing apparatus and warning messages to the user, and turns off the display thereon when the apparatus enters a power saving mode.

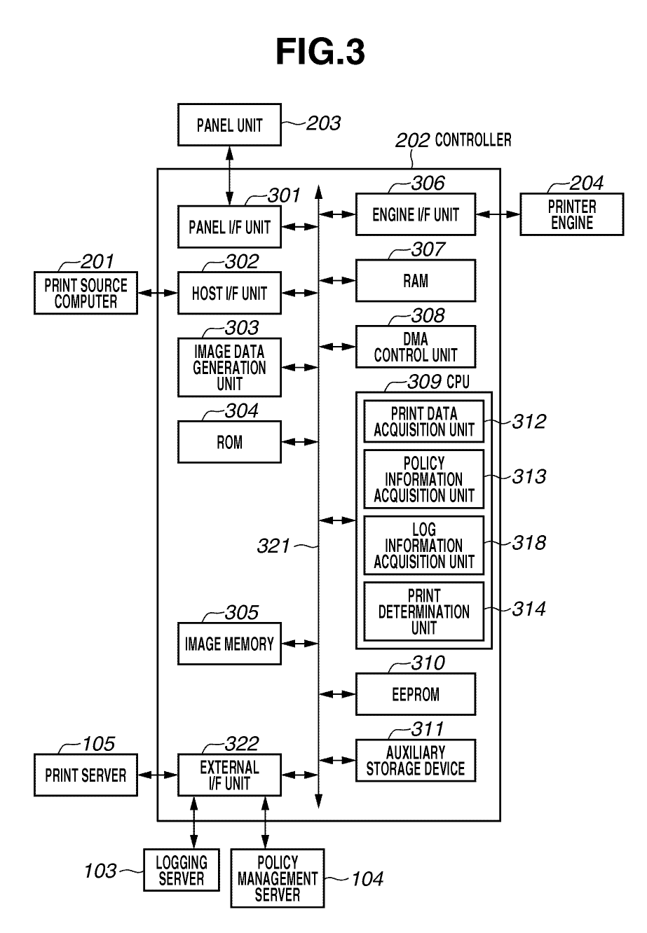

Referring to FIG. 3, a detailed configuration of the printing apparatus 102 will be described. FIG. 3 illustrates an example of the detailed configuration of the printing apparatus. The controller 202 includes a panel interface (I/F) unit 301, a host I/F unit 302, an image data generation unit 303, a read-only memory (ROM) 304, and an image memory 305. The controller 202 further includes an engine I/F uni5 306, a random access memory (RAM) 307, a direct memory access (DMA) control unit 308, a central processing unit (CPU) 309, an electrically erasable and programmable read only memory (EEPROM) 310, an auxiliary storage device 311, and an external I/F unit 322.

The panel I/F unit 301 communicates data with the panel unit 203, and notifies the CPU 309 of contents of setting or instruction input by the user on the panel unit 203. The panel I/F unit 301 further notifies the panel unit 203 of an instruction to the user transmitted from the CPU 309. The host I/F unit 302 connects to and bidirectionally communicates with information terminal devices, such as a personal digital assistant (PDA), a cell phone in addition to the client PC 101 and the print server 105 via an information transmission medium, such as a communication network and a universal serial bus (USB). The engine I/F unit 306 is connected to the printer engine 204. Thus, the CPU 309 can control signals via the engine I/F unit 306, and recognize a state of the printer engine 204 from received signals.

The image data generation unit 303 generates raster data (rasterizes data) to be supplied to the printer engine based on image information, such as page description language (PDL) supplied from the print source computer 201. The image memory temporarily stores generated raster data. The CPU 309 controls devices connected to a CPU bus 321 based on a program stored in the ROM 304 or the auxiliary memory device 311.

The RAM 307 is a temporary storing memory used by the CPU 309, and has a configuration that can expand an amount of memory by attaching an optional RAM to an expansion port (not shown). The RAM 307 can serve as a drawing object storage area which stores a drawing object, and a work memory which is temporarily used by a control program stored in the ROM 304. The EEPROM 310 is formed by a non-volatile memory to store control information, such as a density correction table.

The DMA control unit 308, in response to an instruction from the CPU 309, transfers the raster data from the image memory 305 to the engine I/F unit 306. The auxiliary storage device 311 is, for example, a hard disk to store print data and other control information. The Data stored in the auxiliary storage device 311 is read to the RAM serving as the main memory device, and used by the CPU 309. The external I/F unit 322 communicates with the logging server 103, the policy management server 104, and the print server 105 via the network to confirm and acquire log information and policy information.

A print data acquisition unit 312, a policy information acquisition unit 313, a log information acquisition unit 318, and a print determination unit 314 can be realized when the CPU 309 loads a control program from the ROM 304 or the auxiliary storage device 311 and executes the control program. The print data acquisition unit 312 acquires print data from the host I/F unit 302 via an information transmission medium, such as the communication network. The policy information acquisition unit 313 accesses the policy management server 104 via the external I/F unit 322, and acquires policy information about operation of the current log information.

The log information acquisition unit 318 accesses the logging server 103 or the print server 105 via the external I/F unit 322, and acquires log information about a target job. The print determination unit 314 determines whether to execute printing according to acquired policy information and/or log information.

The CPU bus 321 transmits a signal including an address, data, and a control bus. Individual components in the controller 202 can access all devices connected to the CPU bus 321.

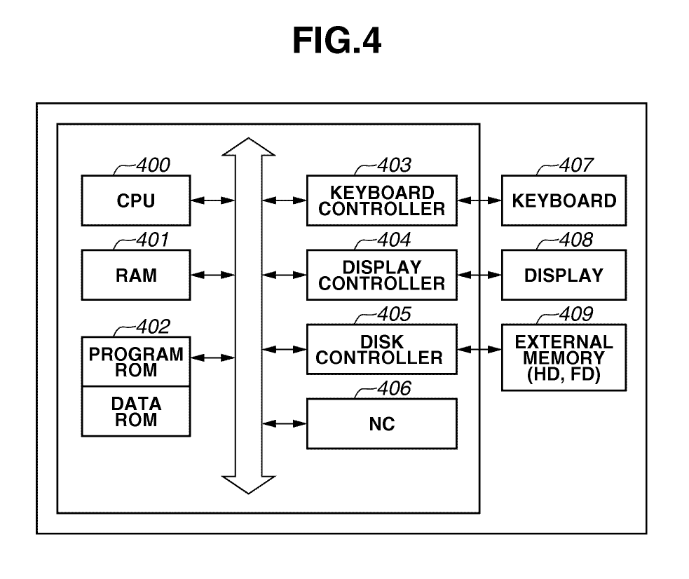

FIG. 4 illustrates an example of the hardware configuration which is common to the client PC, the logging server, the policy management server, and the print server. In FIG. 4, the CPU 400 executes an operating system and application programs which are stored in a program ROM in the ROM 402, or loaded from a hard disk 409 to the RAM 401. Various pieces of processing executed in the client PC 101, the logging server 103, the policy management server 104, and the print server 105 based on each of flowcharts described below can be realized by execution of the programs.

The RAM 401 functions as a main memory and a work area of the CPU 400. A keyboard controller 403 controls key inputs from a keyboard 407 and a pointing device not illustrated. A display controller 404 controls display on various display panels 408. A disk controller 405 controls data access at a hard disk (HD) 409 or a flexible disk (FD) to store various data. A network controller (NC) 406 is connected to the network and executes communication control processing with other devices connected to the network.

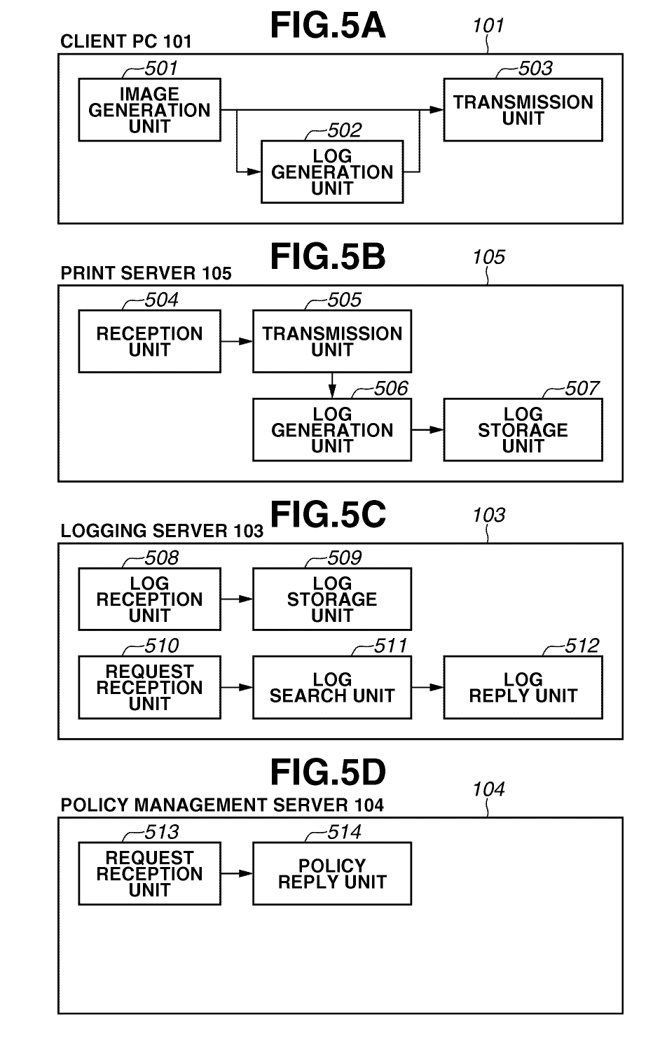

FIGS. 5A through 5D illustrate configurations of software that operates on the client PC 101, the print server 105, the logging server 103, and the policy management server 104, respectively.

In FIG. 5A, an image generation unit 501 which generates print data to be a print object, such as portable document format (PDF) data and PDL data, is generally mounted as a printer driver. It is assumed that, when generating the print data, the image generation unit also generates an identifier (ID) which is uniquely identifiable in the printing system according to the present exemplary embodiment and attaches the generated ID as a job ID to the print data.

A log generation unit 502 generates log information when the client PC 101 generates and transmits the print data. It is assumed that the log information includes a job ID to be able to uniquely identify a printing operation in the printing system according to the present exemplary embodiment.

A transmission unit 503 transmits the print data generated in the image generation unit 501 to the printing apparatus 102 and the print server 105, and also transmits the log information generated by the log generation unit 502 to the logging server 103. The transmission unit 503 may add an identifier which enables discrimination that the transmission source is the client PC 101 including the image generation unit 501 to the print data, when transmitting the print data. The transmission unit 503, when transmitting the print data, may access the policy management server 104, acquires policy information, and transmits the print data added with the policy information.

In FIG. 5B, a receiving unit 504 receives the print data transmitted from the client PC 101. The receiving unit 504 may have a function of managing the received print data as a print job.

A transmission unit 505 transmits the print data received at the reception unit 504 to the printing apparatus 102. When the job ID is not added to the received print data, the transmission unit 505 generates a job ID which is uniquely identifiable in the printing system, and transmits the print data to which the job ID is added. When transmitting the print data, the transmission unit 505 transmits the print data including discrimination information by which it is determined at a received side that print data was transmitted from the print server 105. When transmitting the print data, the transmission unit 505 may access the policy management server 104, acquire the policy information, and transmit the print data to which the policy information is added.

On the other hand, a log generation unit 506 generates log information from information about the transmitted print data, and a log storage unit 507 stores the log information in an external memory, such as a hard disk.

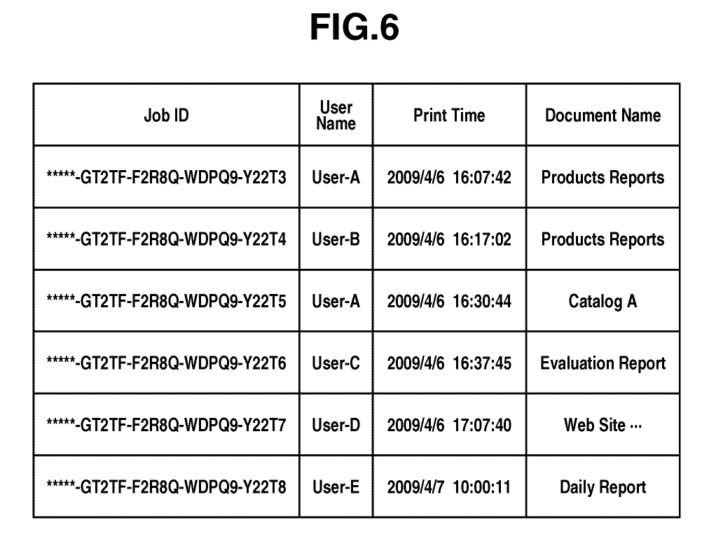

FIG. 6 illustrates an example of log information that the log storage unit 507 stores. The log information includes a job ID, a name of a user who performed printing, time and date when printing was performed (time and date when print data was transmitted to the printing apparatus 102), and a document name of a print object, which are only an example.

In FIG. 5C, a log reception unit 508 receives the log information transmitted from the client PC 101, and a log storage unit 509 stores the log information in an external memory, such as a hard disk. A request reception unit 510 acquires the log information from the printing apparatus 102 or the like, or if a request for confirmation is transmitted thereto, the request reception unit 510 receives the request.

A log search unit 511 extracts a job ID designated by the request received by the request reception unit 510, and searches for corresponding data from the stored log information by using the ID as a search key. A log reply unit 512 transmits the corresponding data as a search result by the log search unit 511 as a reply to the request to a request source.

A request according to the present exemplary embodiment is supposed that the request includes an ID such as a job ID, which can uniquely identify a specific operation, as an input factor and log information linked to the ID is returned to reply to the request. However, it may be configured to use specific time and date, time and date indicating a certain period, and data stored as the log information as the input factors and return log information relating to the input factors.

The log information stored in the log storage unit 509 of the logging server 103 may be thought of as almost the same as the log information stored in the log storage unit 507 of the print server 105, and an example of which is shown in FIG. 6.

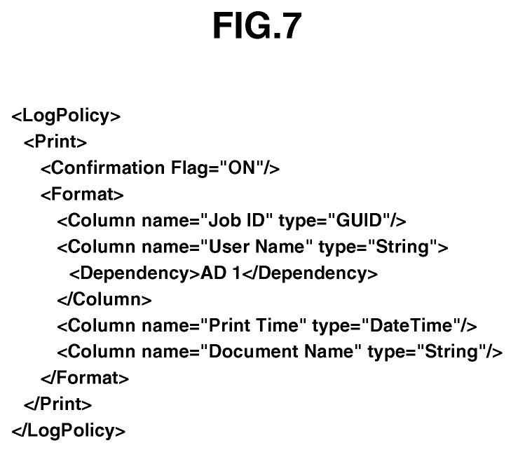

In FIG. 5D, a request reception unit 513 acquires policy information currently used regarding the log information, or accepts a request for confirmation. A policy reply unit 514 transmits the policy information currently used regarding the log information as a reply to the request source. Data to be returned may be in various formats, and an example of policy information regarding the log information which is described in XML format is illustrated in FIG. 7.

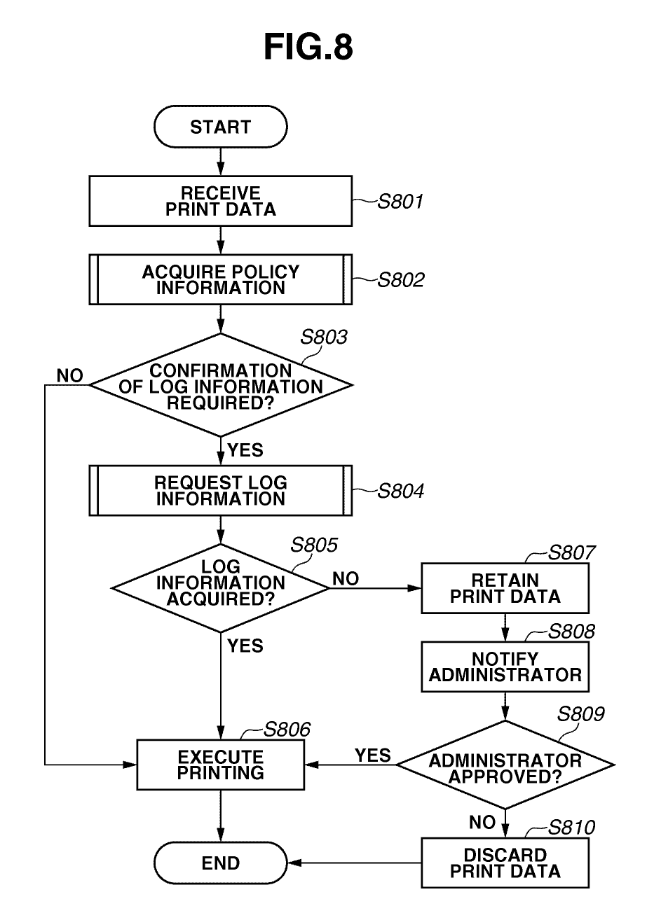

A flow of processing in the printing apparatus according to the present exemplary embodiment will be described with reference to FIG. 8. FIG. 8 is a flowchart illustrating an example of print control processing which is executed in the printing apparatus of the first exemplary embodiment of the present invention.

In step S801, the print data acquisition unit 312 receives print data transmitted from the print source computer 201 via the host I/F unit 302.

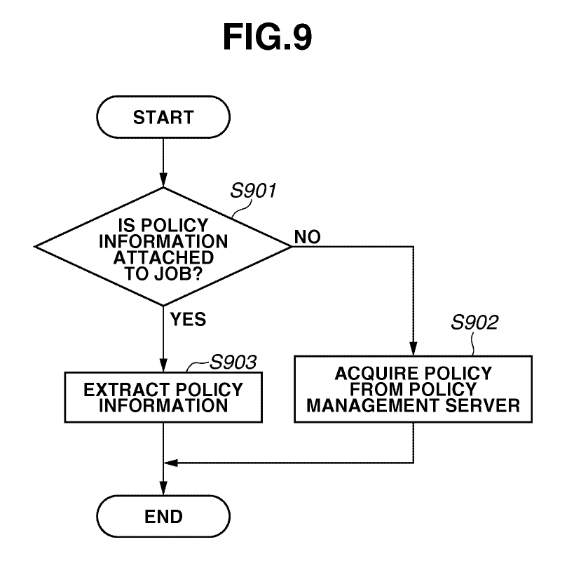

In step S802, the policy information acquisition unit 313 acquires policy information, and its detailed processing is illustrated in a flowchart in FIG. 9. In step S901 in FIG. 9, the policy information acquisition unit 313 determines whether the policy information is attached to the print data received in step S801.

If the policy information is not attached (NO in step S901), then in step S902, the policy information acquisition unit 313 accesses the policy management server 104 via the external I/F unit 322, and acquires the policy information. In step S901, if the policy information is attached to the print data (YES in step S901), then in step S903, the policy information acquisition unit 313 extracts the policy information from the print data.

Returning to FIG. 8, in step S803, the policy information acquisition unit 313 analyzes the policy information acquired in step S802, and confirms a flag to determine whether confirmation of the log information is required at the time of printing. The flag to determine whether confirmation of the log information is required at the time of printing is expressed as “<Confirmation Flag=“ON”/>” in FIG. 7. This means that a policy flag indicating “confirmation of the log information is required at the time of printing” is set in FIG. 7. The expression of policy data in FIG. 7 is a merely example, and may be in any other data form.

If the flag indicates that “confirmation of the log information is not required” (NO in step S803), the processing proceeds to step S806, and the CPU 309 delivers the print data to the printer engine 204 via the engine I/F, to cause the printing apparatus 102 to normally execute printing.

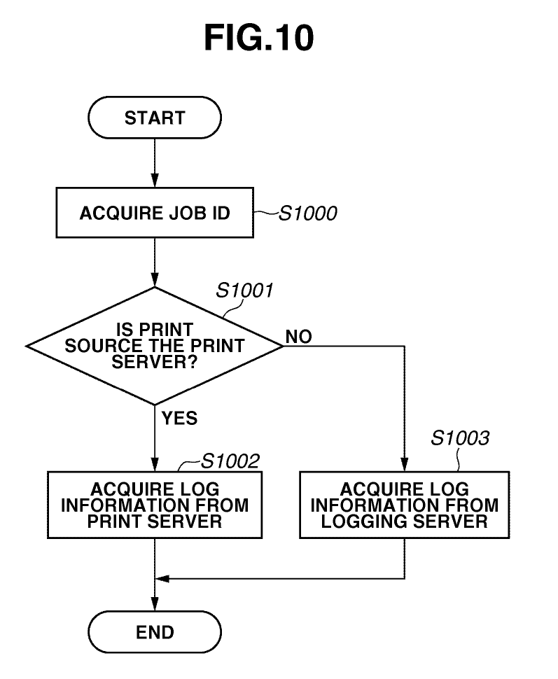

If the flag indicates that “confirmation of the log information is required” (YES in step S803), the processing proceeds to step S804, and the log information acquisition unit 318 attempts to acquire the log information. The processing in step S804 is illustrated more specifically in FIG. 10.

In step S1000, the log information acquisition unit 318 acquires a job ID which is added to the print data received in step S801. In step S1001, the log information acquisition unit 318 refers to print source information added to the print data received in step S801 and determines whether the print source is the print server 105 or the client PC 101.

If the print source is the client PC 101 (NO in step S1001), the processing proceeds to step S1003, and the log information acquisition unit 318 accesses the logging server 103 via the external I/F unit 322 to make a request for log information related to the job ID acquired in step S1000. On the other hand, if the print source is determined as the print server 105 (YES in step S1001), then in step S1002, the log information acquisition unit 318 accesses the print server 105 via the external I/F unit 322, to make a request for log information related to the job ID acquired in step S1000.

Returning to FIG. 8, in step S805, the print determination unit 314 determines whether the log information requested in step S804 has been acquired. If the log information has been acquired (YES in step S805), since it can be confirmed that the log information remains in the print source, the processing proceeds to step S806, and the CPU 309 delivers the print data to the printer engine 204 via the engine I/F, and causes the printing apparatus to execute printing.

On the other hand, in step S805, if the print determination unit 314 determines that the log information has not been acquired (NO in step S805), the processing proceeds to step S807, and the print determination unit 314 stores (retains) the print data in the auxiliary storage device 311. Then, in step S808, the print determination unit 314 notifies an administrator of the retained data by, for example, sending an e-mail via the external I/F unit 322.

The notified administrator determines whether to approve of printing of the print data currently being retained. In step S809, when the print determination unit 314 determines that the administrator approved the printing (YES in step S809), the processing to proceed to step S806. Whereas, when the print determination unit 314 determines that the administrator did not approve the printing (NO in step S809), the processing to proceed to step S810. In step S806, the CPU 309 delivers the print data to the printer engine 204 via the engine I/F, and causes the printing apparatus to execute printing. In step S810, the print determination unit 314 discards the print data, and terminates a series of processing.

By the processing described above, regardless of whether the print source is a driver or a print server, if the log information is not set to be output or if a component capable of outputting the log information is not installed, the printing apparatus 102 can perform control to prohibit printing not to output data to paper.

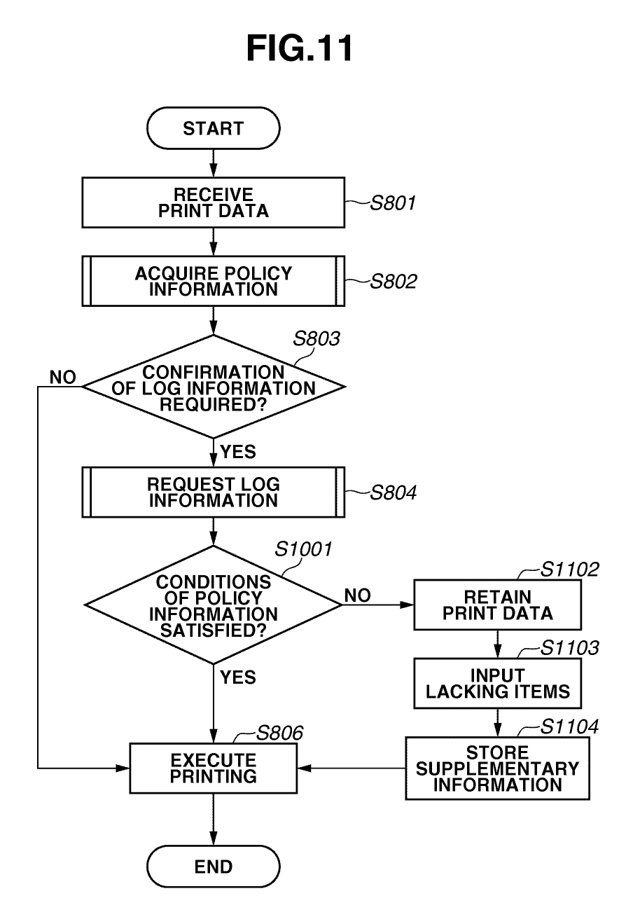

In the first exemplary embodiment, so long as the print source outputs the log information, the printing apparatus 102 performs print processing. In a case where the log information is used as subject to an audit, it is important whether contents related to a policy are recorded in the log information. Therefore, in a second exemplary embodiment of the present invention, processing executed in the printing apparatus 102 for considering whether log information output by a print source complies with a policy will be described below with reference to a flowchart in FIG. 11.

FIG. 11 is a flowchart illustrating an example of print control processing to be executed in the printing apparatus according to the second exemplary embodiment.

Processing in steps S801 to S804 in FIG. 11 are similar to those in steps S801 to S804 in FIG. 8. In step S1101, the print determination unit 314 acquires the log information requested in step S804 and compares the log information with the policy information acquired in step S802. For example, in the policy information in FIG. 7, there are designated, “Job ID” of a global unique identifier (GUID) type, “User Name” of a character string type, “Print Time” of a DateTime type, and “Document Name” of character string type. Thus, these items need to be recorded in the log information by designated data types. The print determination unit 314 confirms whether acquired log information satisfies such conditions of the policy information.

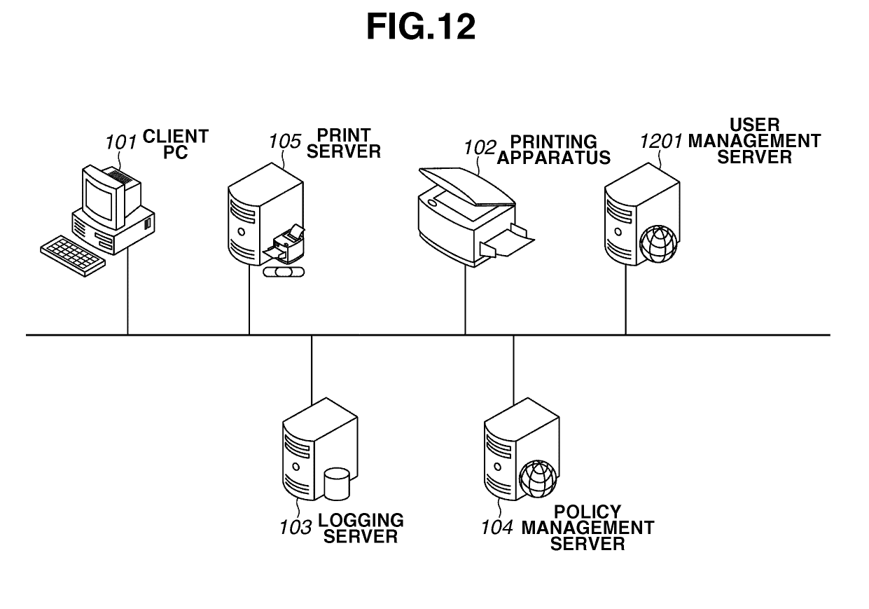

In the item “User Name” of the policy information in FIG. 7, a dependency parameter is designated as a <Dependency> element. This is based on the assumption that as illustrated in FIG. 12, there is a user management server 1201 which collectively manages user information, such as a lightweight directory access protocol (LDAP) server, in the environment in which the present system is operating. The policy in FIG. 7 is illustrated as being dependent on an “AD_1” user management server.

In this case, the print determination unit 314 may access the user management server 1201 via the external I/F unit 322, and confirm whether there is a user recorded in the log information. As a result of determination by the print determination unit 314 as to whether the log information satisfies the conditions of the policy information, if the log information satisfies the conditions of the policy information (YES in step S1101), the processing proceeds to step S806. On the other hand, if the log information does not satisfy the conditions of the policy information (NO in step S1101), the processing proceeds to step S1102.

In step S806, the CPU 309 delivers the print data to the printer engine 204 via the engine I/F, and causes the printing apparatus to execute printing. In step S1102, the print determination unit 314 stores (retains) the print data in the auxiliary storage device 311.

With regard to the retained print data, in step S1103, the user may input data for lacking items via the panel unit 203 or the like. Then in step S1104, the print determination unit 314 may stores the user-input data as supplementary information for the log information in the logging server 103 via the external I/F unit 322. When storage of the supplementary information for the log information is completed, the processing proceeds to step S806, and the CPU 309 may deliver the print data to the printer engine 204 via the engine I/F, and causes the printing apparatus to execute printing.

According to the above described processing, by allowing printing after determining whether the log information output from the print source complies with the policy, policy-based log information can be mandatorily output.

According to the above described exemplary embodiments, if the print source does not output the log information, the printing apparatus can perform control to prohibit printing not to output data on paper.

Aspects of the present invention can also be realized by a computer of a system or apparatus (or devices such as a CPU, a micro-processing unit (MPU), and/or the like) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-181874 filed Aug. 4, 2009, which is hereby incorporated by reference herein in its entirety.

What is claimed is:

1. A printing apparatus comprising:
a log information acquisition unit configured, if a print source is a print server, to acquire log information from the print server, or if the print source is a client apparatus, to acquire log information from a log management server in which the client apparatus writes the log information; and
a control unit configured to execute printing related to a print job when the log information is acquired by the log information acquisition unit.

2. The printing apparatus according to claim 1, wherein the control unit executes printing related to the print job if the log information is acquired by the log information acquisition unit and the acquired log information complies with policy information related to the log information.

3. The printing apparatus according to claim 1, wherein the log information acquisition unit determines whether the print source is the print server or the client apparatus based on the print job, and if the print source is the print server, the log information acquisition unit acquires the log information from the print server, and if the print source is the client apparatus, the log information acquisition unit acquires the long information from the log management server in which the client apparatus writes log information.

4. The printing apparatus according to claim 1, further comprising a policy information acquisition unit configured to acquire policy information related to the log information,
wherein the log information acquisition unit determines whether to confirm the log information based on the policy information acquired by the policy information acquisition unit, and if it is determined to confirm the log information, the log information acquisition unit acquires the log information.

5. The printing apparatus according to claim 4, wherein if the policy information is included in the print job, the policy information acquisition unit acquires the policy information from the print job, and if the policy information is not included in the print job, the policy information acquisition unit acquires the policy information from a policy management server.

6. A method for controlling printing executed by a printing apparatus, the method comprising:
if a print source is a print server, acquiring log information from the print server;
if the print source is a client apparatus, acquiring log information from a log management server in which the client apparatus writes the log information; and
executing printing related to a print job when the log information is acquired.

7. A computer-readable storage medium storing a program to execute the method according to claim 6.
